(19) United States
(12) Patent Application Publication
(10) Pub. No.: US 2012/0188069 A1
(43) Pub. Date: Jul. 26, 2012

(54) DEVICE FOR MONITORING A VEHICLE WHEEL

(75) Inventors: Paolo Colombo, Alessandria (IT); Domenico Cantarelli, Casale Monferrato (Alessandria) (IT)

(73) Assignee: ELTEK, S.P.A., Casale Monferrato (AL) (IT)

(21) Appl. No.: 13/388,418

(22) PCT Filed: Aug. 3, 2010
(86) PCT No.: PCT/IB2010/053515

§ 371 Date: Apr. 13, 2012

(30) Foreign Application Priority Data
Aug. 4, 2009 (IT) TO2009A000610

(51) Int. Cl. B60C 23/04

(52) U.S. Cl. 340/447

(57) ABSTRACT

A device for monitoring the tire of a wheel of a vehicle is configured for detecting and transmitting to a receiver, through a wireless connection, information regarding at least one characteristic quantity of a state of the tire, in particular its inflating pressure. The monitoring device has a body for housing a circuit designed to transmit the information to the receiver. The body includes a first body part, made of a first material, and a second body part made of a second material, the first and second body parts defining between them a housing for the circuit. At least the second material is a synthetic material having an electrical permittivity that is substantially constant at the at least one predetermined frequency. Preferably the first and second body parts are rigid and are fixed together by clinching or local mechanical deformation of the first body part on the second body part.

### FIELD OF THE INVENTION

The present invention relates to a device for monitoring a wheel of a vehicle. More in particular, the invention regards a device of the above sort designed for detecting one or more characteristic quantities that may be used for checking tyres, such as for example their pressure, and for transmitting information representing said quantity or quantities. Even more in particular, the invention regards a device of the above sort that is to be fixed to the wheel of the vehicle and is designed to transmit via radio the aforesaid information to a receiver system, for example installed on the body of the vehicle or inside its passenger compartment.

The invention has the aim of guaranteeing, in a simple and inexpensive way, a high reliability of operation of the monitoring device.

### PRIOR ART

Devices for monitoring tyres for wheels of vehicles are known and usually identified with the acronym “TPMS” (Tyre-Pressure Monitoring System). Said devices typically comprise a circuit arrangement having a detection part, dedicated to detection of one or more quantities of interest, and a control part, dedicated to processing and transmission of signals. The detection part includes one or more sensors, for detection of one or more quantities to be monitored, typically represented by the inflating pressure and possible other quantities that can affect the operating characteristics of the tyre (such as for example the ambient temperature, the temperature of the tyre, the dry/wet conditions of the road surface). The electrical signals generated by the sensor means are processed by the control part and transmitted by this to a receiver system set on the body of the vehicle or inside its passenger compartment. Transmission of the information from the monitoring device to the receiver system occurs in wireless mode, typically in radiofrequency.

In some TPMS devices the control-circuit part is provided with a supply source of its own, comprising one or more miniaturized batteries. In other known TPMS devices, the device is instead without battery. For this purpose, in some solutions the circuit part of the device is supplied via a piezoelectric generator, which exploits the vibrations in the tyre for generating a voltage; in other solutions, the device is instead of a “passive” type, i.e., it is prearranged so as to react to a specific inductive electromagnetic field produced by a respective reader and supply in response a modulated radiofrequency representing data: consequently, since these passive devices do not have any internal source of energy, they derive their supply from the electromagnetic field generated by the reader.

In some solutions, the device is fixed at the rim bead, i.e., the annular part of the rim that defines the channel in which the tyre is installed. In these solutions, the device is typically integrated in or associated to a retention valve of the tyre, within the channel in which the tyre is installed (see, for example, the documents U.S. 2003/066343, EP 1524133, and U.S. Pat. No. 6,101,870). In other solutions, the device, typically of a passive type, is integrated directly in the body of the tyre, coated by the vulcanized rubber that constitutes the tyre (see, for example, the documents WO 2005/021292, and EP0505905).

In the known solutions, the quality of the transmission of the information is affected by the rubber constituting the tyre and/or by metal parts that are located in the area of installation, which belong to the rim or to the reinforcement structure of the tyre; this has as consequence that the distance of communication is generally short, and the transmission can be affected by disturbance. Other problems of the known art are linked to the fact that, with the passage of time, the integrity of the device can fail on account of the continuous stresses, such as vibrations, due to the use of the vehicle. The known solutions are moreover in general relatively complicated and costly.

U.S. 2009/071238 discloses an assembly for monitoring the pressure of a tyre, having a casing consisting of a number of parts made of thermoplastic or thermosetting material, designed to be fixed on the outer part of the vehicle rim.

WO 9704971 discloses a deflation detector, for detecting when the tyre of a wheel becomes deflated, and for supplying such an indication to the vehicle driver. In this solution the detector has a casing formed of rubber, assembled on the wheel rim so as to protrude partly outside the same rim.

### SUMMARY OF THE INVENTION

In view of what has been set forth above, the object of the present invention is to provide a device of the type indicated having a high reliability of operation, as regards the quality of transmission of the radio signals between the device and a corresponding receiver system. Another object of the invention is to provide a device of the above sort that will be simple and inexpensive to produce. A further object of the invention is to provide a device of the above sort that will present a high reliability of operation also as regards its mechanical structure and resistance to external stresses.

One or more of the above purposes are achieved, according to the invention, by a monitoring device having the characteristics of Claim 1. Advantageous characteristics of the device are indicated in the dependent claims. The claims form an integral part of the technical teaching provided herein in relation to the invention.

In brief, the invention relates to a device for monitoring the tyre of a wheel of a vehicle, configured for at least detecting and transmitting to a receiver system, through a wireless connection, information regarding at least one characteristic quantity of the state of the tyre, in particular its inflating pressure, said device having a body for housing a circuit designed to transmit the information to the receiver system, at at least one substantially predetermined radiofrequency. According to the invention, the aforesaid body is prearranged for being fixed to the wheel in a position external to the tyre, i.e., not integrated in the tyre or in the material forming the tyre, and comprises at least one first body part, made of a first material, and at least one second body part made of a second material, the first and second body parts defining between them a housing for the circuit, the second material being a synthetic material having an electrical permittivity that is predefined and/or substantially constant at said at least one predetermined frequency, in particular for improving the efficiency of transmission and/or reception at said frequency.

Thanks to these characteristics, the transmission of the signals from the device to the receiver system is facilitated, and hence of improved quality and reliability, in the various environmental conditions of use of the device. Furthermore, the second body part can be conveniently obtained via simple injection moulding of plastic material.

In one embodiment, the first and second body parts are rigid and fixed together via clinching or local mechanical deformation of the first body part on the second body part. In this way, the parts of the body of the device can be constrained to one another with a simple and inexpensive technique, which at the same time guarantees a high mechanical strength of the coupling.

In one embodiment, the aforesaid synthetic material is a rigid plastic material, in particular a plastic material having a value of electrical permittivity substantially approaching or equal to 3. In this way, in addition to the advantage of the possibility of obtaining the second body part via moulding of plastic material, the quality of the transmission of the data can be considerably improved, in particular when this occurs at frequencies comprised substantially between 315 and 868 MHz, which are the preferred frequencies of transmission. Materials preferred in this sense, designed also to guarantee a high resistance to stresses of a mechanical nature, are the resins with a base of polyphthalamide or PPA. Preferably, the material constituting the first body part is a metal material and, as such, is designed to guarantee a considerable strength of the casing of the device, in particular in the part thereof that is to provide mechanical fixing of the device. In this perspective, the first body part can also be constituted by the body of a retention valve, fixed to the rim of the wheel at a corresponding through hole that faces the chamber of the tyre. Moreover, also the first body part may be made of a synthetic material having a constant electrical permittivity, in which case the first and the second material can coincide.

In one embodiment, at least one of the first body part and second body part is configured for holding the circuit in a predetermined position within the housing, without the aid of specific fixing members. For this purpose, preferably, the circuit has a circuit support, and the second body part is provided, in a portion thereof facing the inside of the housing, with means for positioning the circuit support. In this way, any possible errors of assembly and risks of possible displacement of the circuit within the corresponding housing are avoided. Once again preferably, for this purpose the first body part defines a bottom of the housing, and the positioning means belonging to the second body part are configured for loading the circuit support towards said bottom.

In one embodiment, the first body part defines a bottom of the housing, which supports a resilient element, with the circuit that is set between the second body part and said resilient element so as to be supported elastically in the housing. Said characteristic enables both reduction of the vibrations and other possible stresses acting on the circuit part of the device in the course of use of the vehicle and recovery of possible tolerances in the course of assembly of the device.

In one embodiment, the housing of the device comprises a seat that is defined in the first body part and that has an upper or end portion delimited peripherally by a wall of the first body part. This wall is at least in part deformed mechanically, in particular clinched, on a respective surface of the second body part. With such an arrangement the mechanical fit between the two body parts is simplified and readily automatable.

Preferably, operatively set between the first and second body parts is at least one seal element, such as an O-ring, and in particular at least one of the first and second body parts defines a positioning seat for said seal element, in a protected position. The presence of a gasket or the like ensures fluid-tightness and/or tightness in regard to solid bodies between the two body parts, on the one hand preventing entry of foreign bodies within the housing, and on the other ensuring sealing at the pressure of use of the tyre when said pressure is the quantity or one of the quantities detected by the monitoring device.

In one embodiment, the second body part has a bottom portion, an intermediate portion, and a top portion, with the bottom portion that is inserted within the seat of the first body part, adjacent to a peripheral wall thereof, in particular so as to surround the circuit. Advantageously, the thickness of the bottom portion of the second body part is greater than the thickness of the top portion thereof. The greater thickness of the aforesaid bottom portion guarantees a good strength of the second body part in its region of interface with the first body part; on the other hand, the more contained thickness of the top portion, located in the vicinity of which is the transmitting antenna of the circuit, further facilitates transmission of the data.

### BRIEF DESCRIPTION OF THE DRAWINGS

Further purposes, characteristics, and advantages of the present invention will emerge clearly from the ensuing detailed description and from the annexed drawings, which are provided purely by way of explanatory and non-limiting example and in which:

FIGS. 1 and 2 are schematic perspective views of a monitoring device according to the invention;

FIG. 3 is a top plan view of the device of FIGS. 1 and 2, in a condition of use;

FIG. 4 is a cross-sectional view according to the line IV-IV of FIG. 3;

FIG. 5 is a view according to a plane of cross section rotated through 180° with respect to that of FIG. 4;

FIG. 6 is a partially exploded view of the device of FIGS. 1-5;

FIG. 7 is a partially exploded view of a part of a device according to a second embodiment of the invention;

FIGS. 8 and 9 are a side view and a cross-sectional view of a positioning element forming part of the device of FIG. 7;

FIGS. 10 and 11 are perspective views of the element of FIGS. 8 and 9; and

FIG. 12 is a cross-sectional view similar to that of FIG. 5, of the assembled device integrating the element of FIGS. 8-11.

### DESCRIPTION OF PREFERRED EMBODIMENTS OF THE INVENTION

Reference to “an embodiment” or “one embodiment” in the framework of this description indicates that a particular configuration, structure, or characteristic described in relation to the embodiment is comprised in at least one embodiment. Hence, phrases such as “in an embodiment” or “in one embodiment” and the like, that may be present in various points of this description, do not necessarily all refer to one and the same embodiment. Furthermore, the particular configurations, structures, or characteristics can be combined in any adequate way in one or more embodiments. The references used herein are only provided for convenience and do not define the sphere of protection or the scope of the embodiments.

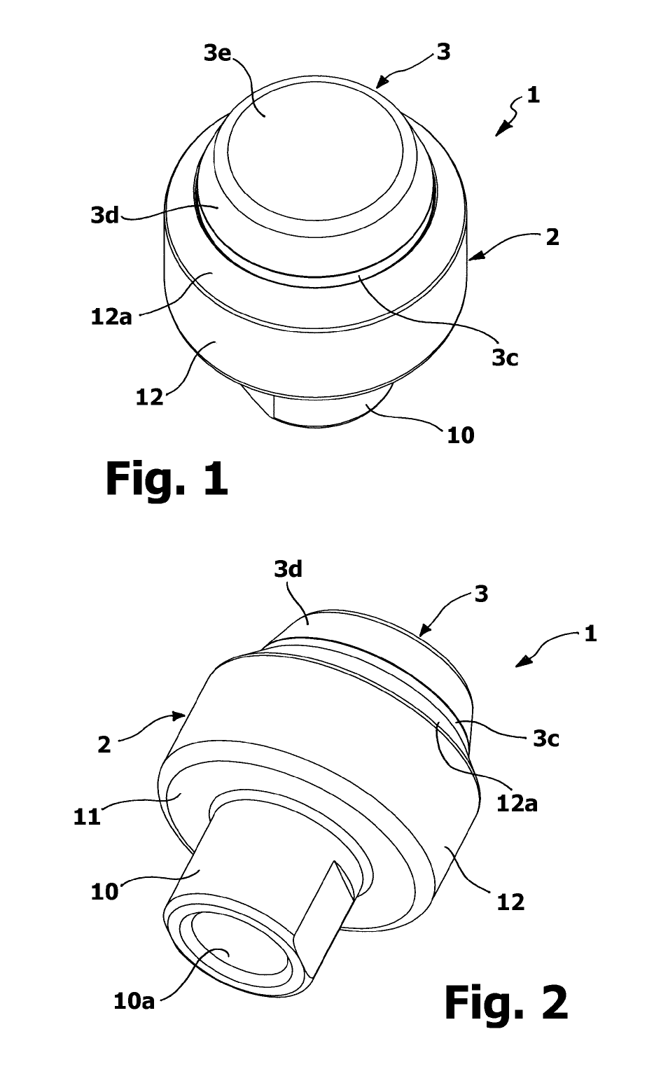

In FIGS. 1 and 2, designated as a whole by 1 is a device for monitoring the tyre of a wheel of a vehicle, obtained in accordance with the specifications of the present invention.

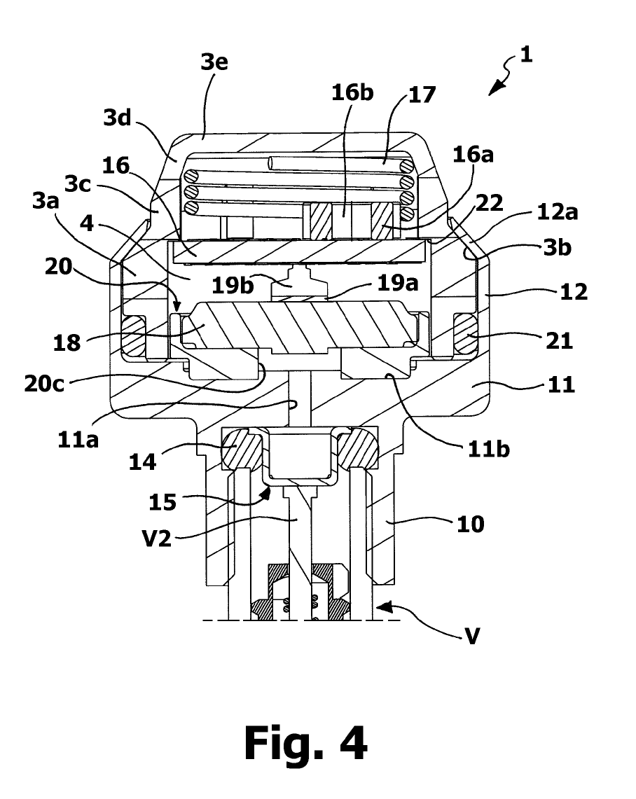

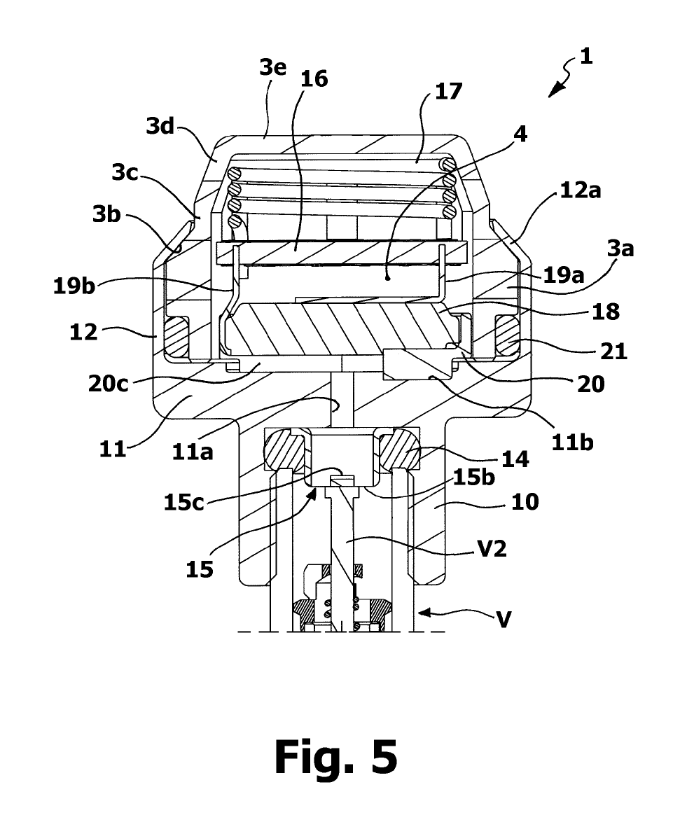

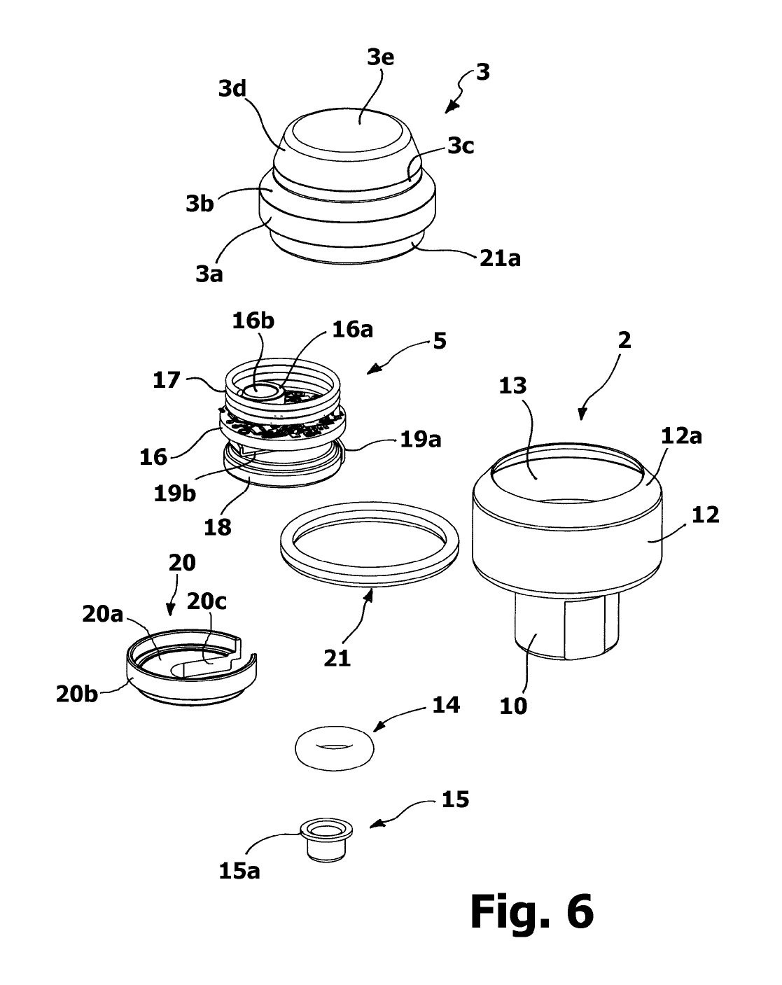

In the embodiment exemplified, the device 1 has a body comprising a first body part 2 and a second body part 3, which are coupled together for providing a casing, defining a housing, designated by 4 in FIGS. 4 and 5, for a circuit, designated as a whole by 5 in FIG. 6. The part 2 basically performs functions of support and connection, whilst the part 3 basically performs functions of lid: in the sequel of the present description, the body parts 2 and 3 will hence be referred to, for reasons of simplicity, as “support” and “lid”, respectively.

The support 2, which is made of a rigid material, preferably of a single piece and of metal material, has a connector portion, an intermediate portion, and a housing portion.

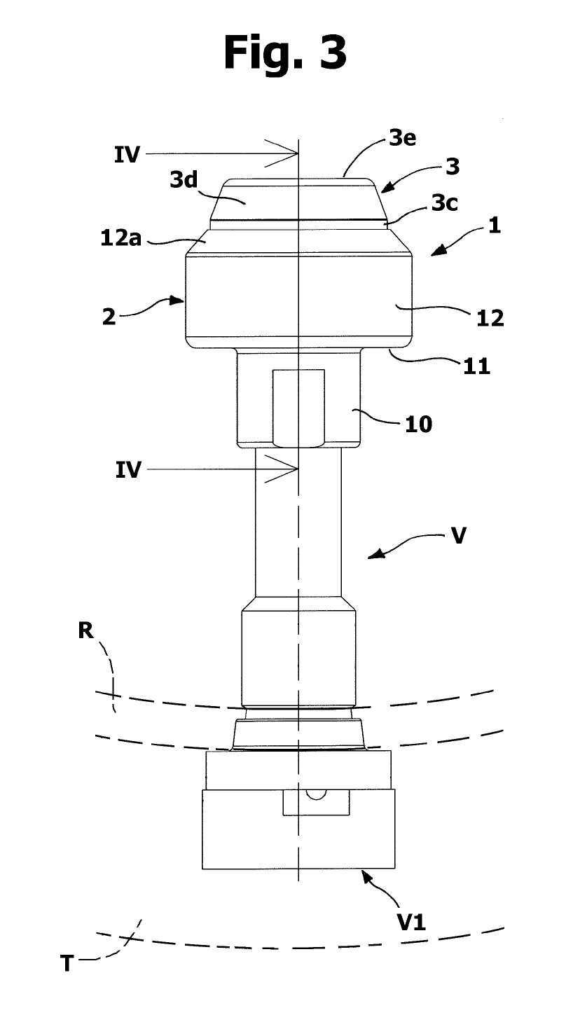

In the non-limiting example of embodiment illustrated in the figures, the device 1 is configured for being installed on a retention valve of the wheel, instead of the usual cap of said valve. The condition of installation is illustrated in FIG. 3, where designated as a whole by V is the aforesaid valve, of a conception and installation in themselves known; the valve V is mounted in a through hole of the rim bead, represented schematically and designated by R, in such a way that the distal end portion thereof V1 is located within the channel for installation of the tyre, schematically designated by T.

In view of said application, and as may be seen also in FIGS. 4 and 5, the aforesaid connector portion of the device, designated by 10, has a generally cylindrical hollow shape, defining a duct 10a (FIG. 2) provided with internal thread that is to co-operate with a thread provided at the proximal end of the body of the valve V.

The aforesaid intermediate portion basically consists of a flange-like wall 11, which extends radially towards the outside from the top or end of the connector portion 10. Rising from the aforesaid flange-like wall 11 is an outer wall 12, which defines peripherally the aforesaid housing portion. In the example, the wall 12 has an annular shape and delimits, together with the wall 11, a cavity or chamber, designated by 13 in FIG. 6.

The wall 11, which forms the bottom of the chamber 13, is traversed by a through hole 11a, which is in fluid communication with the duct 10a of the connector portion.

As may be seen in FIGS. 4 and 5, defined within the connector portion 10 is a seat for an annular installation member 14, such as a ring made of plastic material or elastomer, designed to provide a seal with respect to the valve V and/or to hold in position a pusher element 15, which is to co-operate with the rod V2 of the valve V, said rod being of a type and operating in a way in itself known.

The pusher element 15 has a generally tubular shape, having at its distal end a flange portion 15a (FIG. 6), designed for resting on the wall 11 and preferably held in position via the ring 14, or fixed in some other way. The proximal end of the element 15 has a partially perforated part 15b, or has a bridge part, designated by 15c in FIG. 5. As emerges in particular from FIG. 5, in the mounted condition of the device 1, i.e., with the connector portion 10 screwed right down on the threaded proximal end of the body of the valve V, the bridge part 15b keeps the stem V2 of the valve in a pressed condition, or in a condition of opening of the valve itself. In this condition, the pressure of the air that inflates the tyre can be transferred into the duct 10a and, via the hole 11a of the wall 11, into the housing of the circuit 5 so as to enable monitoring of the pressure, as described hereinafter.

In the example represented, the circuit 5 comprises a circuit support 16, or PCB, made of insulating material, for example fibreglass, mounted on which are electrical and electronic circuit components; the specific circuit arrangement will not be described in detail, its general functions being obtainable in a way in itself known.

It is pointed out, however, that, in a preferred embodiment, mounted on the top surface of the circuit support 16 is a tubular body, designated by 16a in FIGS. 4 and 6, which surrounds a pressure sensor, which is also mounted on the circuit support 16, in particular a sensor of an absolute type, preferably made of semiconductor material. Present within the tubular body 16a is a protective gel 16b, which coats the aforesaid sensor: the arrangement is such that, in the presence of a pressure within the housing 4, this pressure is exerted on the gel 16b, and transferred from this to the sensor, which consequently generates a signal representing said pressure.

According to a technique in itself known, the circuit arrangement provided on the circuit support 16 includes means for processing and/or conditioning the signal generated by the aforesaid sensor, as well as means for transmitting the corresponding pressure information in wireless mode, in particular in radiofrequency, to a receiver system, not represented, which is also of a type in itself known. The transmitting means include an antenna, designated by 17, basically constituted by a metal wire wound in a spiral. The transmitting part of the circuit 5 is preferably configured for operating at a substantially constant frequency; in preferred embodiments of the invention, the aforesaid frequency falls in the range substantially comprised between 100 and 999 MHz, in particular between 315 and 868 MHz; preferred frequencies of use are 315, 434 and 868 MHz, which prove the most suitable for the application.

It is to be noted that, according to one embodiment, the device can be prearranged also for receiving data, for example configuration data, from an external transmitter; consequently, in said embodiment the circuit arrangement also comprises receiving means; the transmitting and receiving means can be conveniently obtained on one and the same transceiver device.

The circuit 16 further includes a supply source, represented by a button battery 18, as well as contact elements, designated by 19a and 19b in FIGS. 4-6, connected to the circuit arrangement mounted on the circuit support 16, for its supply.

It should be noted that in the present description, the term “circuit” and the reference number 5 designate as a whole the assembly formed by the circuit support 16 with the corresponding circuit components, the antenna 17, the battery 18, and the corresponding contact elements 19a-19b. It should be moreover pointed out that, according to a possible embodiment alternative to the one represented, the circuit part of the device according to the invention can be of the type without battery and corresponding contact elements, for example implemented according to the technologies mentioned in the introductory part of the present description, in relation to TPMS devices of the type defined as “passive” or else provided with a voltage generator that exploits the vibrations of use of the tyre, typically a piezoelectric generator.

Designated as a whole by 20 is an element for positioning the circuit 5. In the example represented (see in particular FIG. 6), the element 20 has a generally circular profile, with a bottom wall 20a and a peripheral wall 20b. In the example, the wall 20b is annular and has a diameter such as to receive therein, with slight interference, a bottom portion of the circuit 5, here represented by the battery 18. In the case of a circuit 5 without battery, there can be housed directly within the wall 5 the circuit support 16 or a piezoelectric voltage generator.

In the embodiment illustrated, the body of the element 20 is preferably provided with a groove or through cavity 20c, which extends radially substantially from the central area of the bottom 20a up to its peripheral rim. As will emerge clearly hereinafter, the cavity 20c has the function of facilitating transmission of the air pressure from the hole 11 a of the wall 11 towards the top part of the housing 4, operatively positioned in which is the aforesaid pressure sensor. The bottom of the housing 4, formed by the wall 11, can possibly define a positioning seat for the element 20, as represented schematically in FIGS. 4 and 5, where said seat is designated by 11b.

As mentioned previously, at least the lid 3 is made of a synthetic material, in particular a plastic material, even more in particular an injection-mouldable thermoplastic material. According to one aspect of the invention, as already highlighted, the material used has an electrical permittivity that is predefined and/or substantially constant at the preferred frequencies of use of the circuit 5, such as to improve the efficiency of transmission and possible reception at said frequencies, in various environmental conditions of temperature and humidity.

The preferred material is a plastic material having a value of electrical permittivity equal or close to 3.

In the preferred embodiment the plastic material used is a resin with a base of polyphthalamide or PPA, preferably without fillers. Said class of materials enables various requirements underlying the invention to be met. In the first place, the materials in question have, precisely, an excellent constancy of electrical permittivity in various conditions of ambient temperature and humidity. PPA-based resins absorb in fact an extremely low amount of humidity from the surrounding environment and guarantee a good constancy of the characteristics, for example of the parasitic capacitances, in a wide range of environmental conditions and temperatures. Another advantage of the materials in question is represented by their low dissipation factor, which means that the radiofrequency signals generated by the circuit 5 are effectively transmitted on the outside of the casing, instead of being attenuated or dispersed, for example by heating the plastic material. Another advantage is that PPA-based resins are conveniently injection-mouldable and have a contained cost as compared to other rigid materials. The materials in question are moreover mechanically strong, i.e., perfectly able to withstand the mechanical stresses to which the device 1 can be subjected in use (such as for example the impact of gravel lifted up by the wheel during the use of the vehicle or the mechanical stresses of assembly or clinching). Other polymeric materials having a substantially constant electric permittivity, which can be used for implementing the invention, are the PCT high-temperature polyester (poly(cyclohexylene-dimethylene)terephthalate) and the syndiotactic polystyrene (SPS).

The body of the lid 3 is hollow and has a bottom part, defined by a substantially cylindrical peripheral wall 3a. The wall 3a has, at the top end, a generally flared or frusto-conical outer portion, designated by 3b. At the top of said flared portion 3b, the body of the lid 3 proceeds in a generally cylindrical second wall 3c, which narrows to form a frusto-conical wall 3d and then a substantially plane top wall 3e.

As may be noted in particular from FIGS. 4 and 5, the wall 3a is to be housed within the seat 13 (FIG. 6) of the support 2, set up against the wall 12, possibly with a slight interference with respect thereto, and resting on the wall 11.

The body of the lid 3 has portions of different thicknesses. In particular, from FIGS. 4 and 5 it may be noted how the walls 3c-3e, in particular the walls 3d-3e, have a small thickness as compared to the wall 3a; said small thickness facilitates transmission in radiofrequency, disturbing it only to a minor extent. As may be noted, in fact, located in the top region of the cavity of the lid 3, delimited precisely by the walls 3c-3e, when the device 1 is in the assembled condition, is the transmitting antenna 17.

For the purposes of assembly of the body of the device, the wall 3a of the lid 3 is inserted in the seat 13 of the support 2 and, then, the top portion of the wall 12 of the body 2, designated in the figures by 12a, is deformed mechanically, via clinching, so that it will bear upon the flared portion 3b of the lid 3 (it should be noted that, in FIG. 6, the portion of wall 12 is represented in the already deformed condition, merely for requirements of clarity). In this way, a precise and firm mechanical fit between the parts is guaranteed.

In the figures, designated by 21 is a seal element, operatively set between the support 2 and the lid 3, which, in the example represented, is constituted by an O-ring. Preferably, said seal element 21 is housed in a protected position, and for this purpose defined in at least one of the surfaces facing the support 2 and the lid 3 is a corresponding positioning seat. In the example represented, said seat, designated by 21a (FIG. 6), is obtained in the lid 3, and precisely in the bottom region of the wall 3a facing the wall 12.

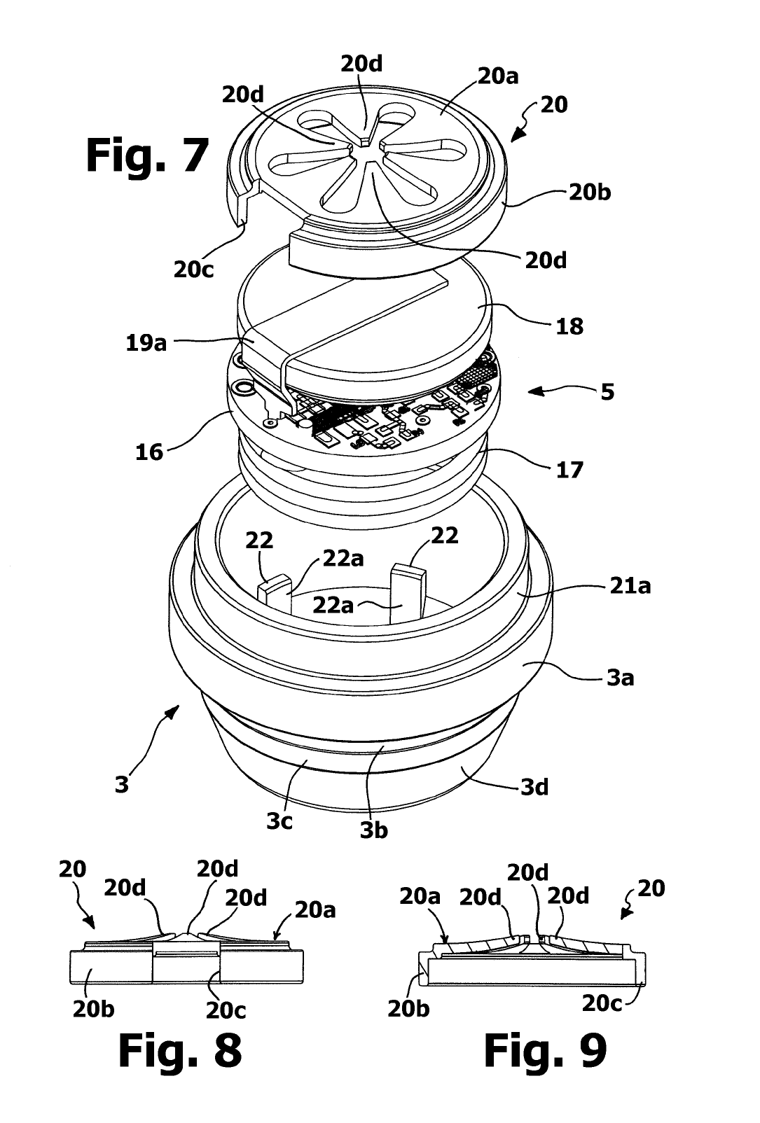

It should once again be pointed out that, in the preferred embodiment, the lid 3 is configured for keeping the circuit 5 in a predetermined position within the housing 4. For this purpose, in the embodiment exemplified, defined in a portion of the lid 3 that faces the inside of the housing 4, are positioning means 22. In the non-limiting example represented, these means comprise at least one seat or a step, formed basically in the area of transition between the walls 3a and 3c, the peripheral part of the circuit support 16 possibly bearing upon said step 22. It will be appreciated, in this regard, that the peripheral encumbrance or external diameter of the antenna 17 is less than the peripheral encumbrance or diameter of the circuit support 16. As may be seen in FIG. 7, the aforesaid positioning means can advantageously comprise a plurality of radial or axial reliefs 22a, defined on the internal part of the lid 3, each of which defining a respective step or resting surface 22.

The positioning means 22, and hence the lid 3 as a whole, as well as the circuit 5, are also sized in such a way that the circuit support 16 is forced towards the bottom of the housing, defined by the wall 11.

As explained previously, provided on the bottom of the housing is the positioning element 20 that, in one embodiment, in particular, is made of a resilient or elastic material, such as for example an elastomer material. In this way, as may be seen in FIGS. 4 and 5, the circuit 5 is set between the lid and the resilient element 20: given the presence of the step or steps 22 that pushes/push the circuit 5 towards the wall 11, the circuit itself is supported elastically in the housing 4. In this way, the circuit 5 is not particularly subject to the vibrations caused by use of the wheel. Said elastic installation moreover enables recovery of possible tolerances of production and assembly of the components of the device, also preventing excessive stresses on the circuit, in particular during the steps of assembly. It should also be noted that the antenna 17, the top end of which may be in contact with the lid 3, can contribute to performing these functions of damping and recovery of tolerances.

As previously mentioned, the through cavity 21d of the positioning element 20 is provided to enable transfer of the air pressure into the top region of the housing 4. As may be seen, for example, in FIG. 5, the valve V is kept open via the pusher 15, the bridge 15b of which keeps the rod lowered. The air pressure present in the tyre can thus pass into the duct defined by the connector portion 10 and, through the tubular pusher 15, can traverse the hole 11 that opens in the part of the cavity 20c that is located in the central area of the bottom 20a of the element 20. Via the cavity 20c said air pressure can reach the peripheral part of the cavity itself, which is open towards the wall 12 of the support 2 (see the left-hand part in FIG. 5), and then reach the top part of the housing 4, where the circuit support 16, which bears the tubular body 16a that surrounds the pressure sensor, is located.

As has been said, the sensor generates an electrical signal representing the pressure, with the circuit part provided on the circuit support 16 which, after prior possible treatment and/or processing, transmits it in radiofrequency, by means of the antenna 17, to the receiver system (not represented in so far as it is of a type and operates in a way in itself known). The fact that the material constituting the lid 3 has an electrical permittivity that is substantially constant in various conditions of temperature and humidity enables reduction of the level of alteration of the signal transmitted in radiofrequency and/or a priori knowledge thereof, so that the circuit 5 and/or the receiver system can be configured accordingly in such a way that said alteration of the signal is of no effect for the purposes of transmission.

In the example of embodiment described, the information generated and transmitted by the device 1 regards at least the inflating pressure of the tyre. In possible variants of the invention, in addition or as an alternative to the detection of the pressure, the device 1 can be configured for detecting and transmitting values representing other quantities useful for monitoring the tyre, such as for example the ambient temperature, the temperature of the tyre, the dry/wet conditions of the road surface, the stresses or vibrations during movement, etc., using for this purpose also sensors of a type in itself known, which can possibly be located also in a position remote with respect to the circuit support 16 and connected thereto via appropriate conductors.

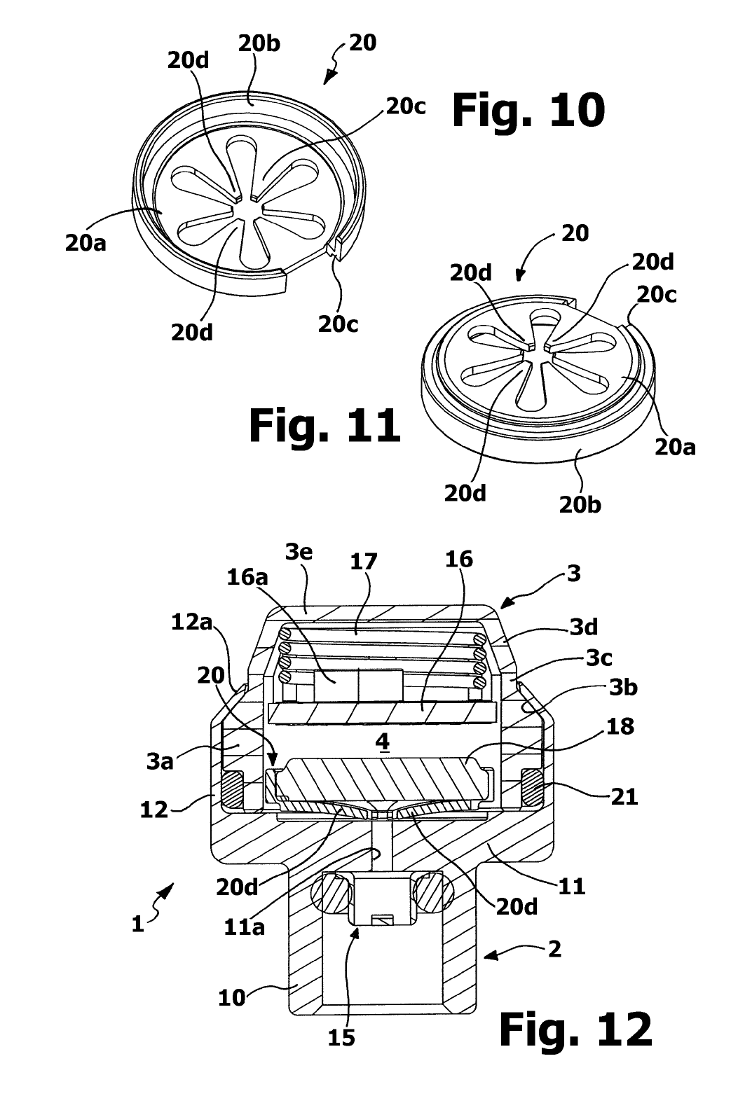

FIGS. 7-12 illustrate an alternative embodiment of the device; in said figures, the same reference numbers as those used in the preceding figures are used to designate elements that are technically equivalent to the ones already described above.

In this embodiment, the positioning element 20 has a body made of relatively rigid material, but in any case prearranged or shaped in such a way as to support the circuit 5 elastically. Also in this embodiment, the element 20 has a bottom wall 20a and a peripheral wall 20b, but the bottom wall 20a defines a series of radial elements or fins 20d, set at a distance apart from one another, which extend substantially in cantilever fashion from the peripheral part up to a central region of the bottom, said fins 20d being able to bend elastically. In the example illustrated, also the cavity 20c is provided, which here extends on the peripheral wall 20b and only slightly on the bottom wall 20a, for receiving a corresponding section of the contact element 19a.

As may be noted, in particular from FIGS. 8, 9 and 12, the body of the element 20 is formed in such a way that the fins 20d are curved or inclined, in particular downwards or outwards, or in a direction opposite to the peripheral wall 20b that defines the bottom seat for the battery 18. The element 20 is preferably formed by moulding of thermoplastic material. As may be seen in FIG. 12 (where the contact elements 19a-19b are not represented), in the assembled condition of the device, the ends without the fins 20d rest on the bottom of the housing 4, or on the wall 11, in an area that substantially circumscribes the outlet of the hole 11a, in a condition of elastic bending caused by the fact that the lid 3 forces the circuit 5 towards the bottom of the housing 4: in this way, the capacity of elastic bending of the fins 20d enables elastic support of the circuit 5 in the housing 4.

The air pressure that reaches the inside of the housing 4, via the hole 11a, can pass between the spaces defined between the fins 20d, as well as between the fins themselves and the battery 18; via the cavity 20c, the pressure can reach the peripheral part of the cavity itself, which is open towards the wall 12 of the support 2, and then reach the top part of the housing 4, where the circuit support 16 with the pressure sensor is located.

Obviously a positioning and elastically supporting element 20 identical or similar to that of FIGS. 7-12 can be used also in the case of a circuit without a battery of its own. Furthermore, the positioning and elastically supporting element 20 could also have a different form, for example be provided with different elastic elements 20d and/or made in a number of parts, and also of a different material, for example provided with a part that is relatively rigid and a part that is elastic, such as a part made of elastic material or elastomer. The positioning and elastically supporting element 20 can also be made of metal material, possibly providing also an electrical connection with the circuit 5 and/or with the metal body 2, i.e., providing the functions of an electrical terminal, albeit maintaining said elastic characteristics and/or functions.

From the foregoing description, the characteristics and advantages of the invention emerge clearly. The device described presents a high reliability and precision of operation in relation to the quality of transmission of the radio signals, which are not affected by the changeable environmental conditions of temperature and humidity in which the device itself has each time to operate. The presence of the lid 3, or of the body part made of material with predefined and/or substantially constant permittivity, renders possible an improved or constant transmission, possibly with a sort of directionality of the radiofrequency signal, with additional advantage in terms of the quality of transmission and the distance covered.

In addition, the device is simple and inexpensive to produce, is distinguished by a high structural strength, and presents a low susceptibility to the stresses or vibrations typically associated to operation of the wheel of a motor vehicle.

It is clear that it is possible for the person skilled in the branch to make numerous variations to the device described purely by way of example, without thereby departing from the scope of the invention as defined in the annexed claims.

In the embodiment previously exemplified the body of the device 1 consists of just two parts, one of which made of metal material. In possible alternative embodiments, the body can comprise more than two parts assembled together, it remaining understood that at least one of said parts, and preferably the part closest to the transmitting means, must be made at least partially of the material having an electrical permittivity that is predefined and/or substantially constant to improve transmission and possible reception of data. Furthermore, the supporting part 2 can possibly be made of mouldable plastic material, preferably with the addition of appropriate fillers, such as reinforcement fillers, to guarantee the necessary solidity; in this case, the fixing between the lid 3 and the supporting part 2, appropriately shaped for this purpose, can be with means different from mechanical clinching, such as for example welding.

In the example of embodiment represented, the device according to the invention is substantially configured as a cap for a common retention valve of a tyre. In a possible alternative embodiment, and without prejudice to its installation on the outside of the structure of the tyre, the device according to the invention can be fixed directly to the rim R of the wheel in a way altogether similar to a normal valve, in a position corresponding to a through hole of the rim R that faces the inside of the channel of the tyre T; obviously, in such an application, the shape of the connector part 10 will be modified with respect to the embodiment illustrated and may present a structure altogether similar to the part for fixing to the rim of an ordinary valve for tyres of motor vehicles. According to another embodiment, again referred to the assembling at a through hole of the rim R, the body of the device according to the invention is shaped for mounting within the installation channel T, but in any case outside of tyre structure. In this embodiment, at least the portion of the housing body made of a material having a constant electric permittivity—which, as seen above, is the portion near the antenna of the device—protrudes through the above said hole outside of the rim, or is substantially flush with the outer surface of the rim, or in any case is arranged or shaped for at least partially facing towards the outside of the rim. In a further possible embodiment, the supporting body of the device, provided with the lid made of material with constant electrical permittivity, can also be obtained directly from the body of the valve of a tyre.

1. A device for monitoring a tire of a vehicle wheel, configured for detecting and transmitting to a receiver, through a wireless connection, information relating to at least one characteristic quantity of a tire status, in particular inflating pressure thereof, wherein the monitoring device comprises:
a body for housing a circuit adapted to transmit said information to the receiver at at least one substantially predetermined radio frequency, wherein the body is prearranged for being fixed to a rim of the wheel, in a position external to the structure of the tire and so as to face at least partly towards the outside of the rim, and wherein the body comprises a first body part, formed at least in part of a first material, and a second body part formed at least in part of a second material, the first body part and the second body part defining therebetween a housing for the circuit, at least the second material being a synthetic material, the second material being a synthetic material having an electric permittivity that is predefined and/or substantially constant at the said at least one frequency, in particular for improving transmission and/or reception efficiency at said at least one frequency.

2. Device according to claim 1, wherein the second material is a rigid material, particularly a rigid plastic material.

3. Device according to claim 2, wherein the second material is a polyphthalamide or PPA based resin.

4. Device according to claim 1, wherein said frequency comprises substantially between 315 and 868 MHz and/or the second material has an electric permittivity value substantially equal or close to 3.

5. Device according to claim 1, wherein the second body part has portions having thicknesses differing from each other, including in particular a base portion and a head portion with the thickness of the base portion being greater than the thickness of the head portion.

6. Device according to claim 1, wherein the first body part and the second body part are prearranged for being mutually fixed through a clinching or a mechanical deformation of the first body part on the second body part.

7. Device according to claim 1, wherein the first body part is formed of a rigid material, particularly a metal material or a rigid plastic material.

8. Device according to claim 2, wherein the first body part and the second body part are mutually fixed by welding.

9. Device according to claim 1, wherein at least one of the first body part and the second body part is configured for maintaining the circuit in a substantially predetermined position within the housing.

10. Device according to claim 1, wherein the circuit has a circuit support and the second body part has, in a portion thereof facing towards the inside of the housing, positioning means for the circuit support, the positioning means comprising in particular a seat or a step defined in said portion of the second body part.

11. Device according to claim 1, wherein
the first body part defines a bottom of the housing and the second body part is configured for biasing the circuit towards said bottom, and/or
within the housing an element is supported, that is at least partly elastically deformable, the circuit being interposed between the second body part and the elastically deformable element so as to be elastically supported within the housing.

12. Device according to claim 1, wherein the first body part has a seat that is peripherally delimited by a wall, which wall has at least one portion mechanically deformed, in particular clinched, onto a respective surface of the second body part.

13. Device according to claim 12, wherein the second body part has a lower portion and an upper portion, the lower portion being inserted within said seat adjacent to said wall, where in particular the lower portion surrounds the circuit and has a greater thickness than the upper portion.

14. Device according to claim 1, wherein between the first and the second body part a sealing element is operatively interposed, such as an o-ring gasket, where in particular at least one of the first body part and the second body part defines a positioning seat (21a) for the sealing element.

15. Device according to claim 1, wherein the first body part is, or belongs to, the body of a tire valve designed to be fixed to the wheel rim at a corresponding through hole.
